(19) United States
(12) Patent Application Publication
(10) Pub. No.: US 2014/0281915 A1
(43) Pub. Date: Sep. 18, 2014

(54) METHOD AND SYSTEM FOR BACKGROUND GENERATION USING GUIDES

(71) Applicant: Minds and Machines, LLC, Santa Monica, CA (US)

(72) Inventor: Frederick R. Krueger, Santa Monica, CA (US)

(73) Assignee: Minds and Machines, LLC, Santa Monica, CA (US)

(21) Appl. No.: 14/205,312

(22) Filed: Mar. 11, 2014

Related U.S. Application Data
(60) Provisional application No. 61/777,096, filed on Mar. 12, 2013.

(51) Int. Cl. G06F 17/22

(52) U.S. Cl. CPC G06F 17/2247
USPC 715/234

(57) ABSTRACT

The claimed subject matter provides a system and/or a method for generating expandable backgrounds for widget elements on a website, blog or ecommerce application, where the backgrounds are generated by taking the nine subimages generated from the subdivision of a given background image with two sets of orthogonal lines. The sub-images are automatically combined into cascading style sheet (CSS) elements, creating HTML backgrounds that seamlessly resize both vertically and horizontally as the content of the element grows.

### STATEMENT OF RELATED APPLICATIONS

The present application claims the benefit of copending U.S. Provisional Patent Application No. 61/777,096, filed on Mar. 12, 2013.

### SUMMARY OF THE INVENTION WITH BACKGROUND INFORMATION

The present invention relates to the generation of backgrounds for images displayed on a computer screen.

The present inventive system and method relates to the generation of backgrounds for images displayed on a computer screen. More particularly, the present invention relates to a method for the generation of widget backgrounds on a web page, online photo gallery or e-commerce site. For ease of reference, any one of a hosted website, an online photo gallery, or an online store will be referred to herein as a “website”. However, it should be understood that the term “website” may refer to any one of a hosted website, an online photo gallery, or an online store.

### BRIEF DESCRIPTION OF THE DRAWINGS

FIGS. 1A-D illustrate the execution of a method according to the present invention.

FIGS. 2-5 are an example illustration of the execution of a method according to the present invention.

FIG. 6 is another example illustration of the execution of a method according to the present invention.

FIG. 7 illustrates an exemplary networking environment, wherein the novel aspects of the claimed subject matter can be employed.

FIG. 8 illustrates an exemplary operating environment that can be employed in accordance with the claimed subject matter.

### DETAILED DESCRIPTION

Referring now to the drawings in general, the illustrations are for the purpose of describing a preferred embodiment of the invention and are not intended to limit the invention thereto.

The present invention provides for the generation of dynamic backgrounds that expand seamlessly as their content grows in size. The method is a technique of web page design. The method consists in creating nine separate, “slices” or “DIV” elements, each with their own background images. The nine images are created by the subdivision of the original background image into nine subimages through the use of four subdividing lines, the four lines consisting of two orthogonal sets of lines, each set having two parallel lines.

The four corner elements generated by this method are fixed and non-repeating. Vertical and horizontal image elements connect these elements, and are set to repeat either vertically if the connector is vertical, or horizontally if the connector is horizontal. The middle area is set to repeat both horizontally and vertically. Because the corners are unchanged, and the edge connector elements are chosen to tile seamlessly in their respective dimensions, this construction ensures that the overall image can expand seamlessly regardless of whether the inner content grows in either the horizontal or vertical directions.

An execution of the method according to the present invention is shown in FIGS. 1A-D. In FIG. 1A a background 10 is provided. Two lines, A-A′ and B-B′, are drawn to define the top and bottom sections of the background, as shown in FIG. 1B. Next, the left and right sections are defined by two lines C-C′ and D-D′ as shown in FIG. 1C. These four lines thus define the corner images 12, 13, 14, 15; the top and bottom horizontal images 16, 17; the left and right vertical images 18, 19; and the center image 20.

The method generates four types of slices or subimages: invariant aspect or untileable, vertically tileable, horizontally tileable, and vertically and horizontally tileable.

The coding for the method uses the html “repeat” command. A slice is defined as a division of the html document (DIV) and the background-repeat property sets if/how the DIV will be repeated. If the image is tileable, the background-repeat property is set to “repeat” for middle sections, “repeat-y” for vertical connector sections, or “repeat-x” for horizontal connector sections. If the image is not tileable, for example, the corners of the background image, then the background-repeat property is set to “no-repeat” for these DIVs.

In a preferred embodiment, adjusting the size of the background does not change the aspect ratio of the corners. Thus, the aspect ratio of these images are fixed, as shown in FIGS. 1C and 1D. In an alternative embodiment, the aspect ratio of the corner images are not fixed and can vary based on the adjustment of the aspect ratio of the background image. Regardless, these divisions of the image are not tileable.

FIGS. 2-5 show an example application of the present invention. In FIG. 2, a content image to which a background is to be applied is selected. In FIG. 3, the content image is imported into software running a background generator according to the present invention. In FIG. 4, a background image for application to the content image is selected and sliced with lines A-A′, B-B′, C-C′ and D-D′. In FIG. 5, the background image is enlarged to fit the content image. The corner images have a fixed aspect in this example, and so the aspect did not vary even thought the aspect of the background image was changed, as can be seen by comparing FIG. 5 with FIG. 4.

The present invention provides for additional subdivision of an image such that more slices or subimages can be prevented from tiling when the image is scaled up or down. FIG. 6 shows an example execution of this method. In this example, two additional slicing lines E-E′ and F-F′ have been added to the background image. These lines divide the horizontal connector segments into three sections: 21, 22 and 23 are the top horizontal connectors and 24,25 and 26 are the bottom horizontal connector. The method preferable holds the aspect ratio of the middle horizontal connectors 22 and 25 fixed, preventing them from being tiled in the x- or y-direction. More preferably, the method holds the aspect ratio of every other connector section fixed. Thus, once the user has drawn the first four lines (A-A′ to D-D′), the user only has to draw two lines on either side of any other sections he desires to have a fixed aspect ratio. In this manner, multiple sections can be defined as having a fixed aspect ratio without the need for more complicated methods.

Such a method also generates multiple middle sections, but these are treated as tileable in both directions.

FIG. 7 is a schematic block diagram of a sample-computing environment 800 with which the claimed subject matter can interact. The system 800 includes one or more client(s) 810. The client(s) 810 can be hardware and/or software (e.g., threads, processes, computing devices). The system 800 also includes one or more server(s) 820. The server(s) 820 can be hardware and/or software (e.g., threads, processes, computing devices). The servers 820 can house threads to perform transformations by employing the subject innovation, for example.

One possible communication between a client 810 and a server 820 can be in the form of a data packet adapted to be transmitted between two or more computer processes. The system 800 includes a communication framework 840 that can be employed to facilitate communications between the client(s) 810 and the server(s) 820. The client(s) 810 are operably connected to one or more client data store(s) 850 that can be employed to store information local to the client(s) 810. Similarly, the server(s) 820 are operably connected to one or more server data store(s) 830 that can be employed to store information local to the servers 820.

With reference to FIG. 8, an exemplary environment 900 for implementing various aspects of the claimed subject matter includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable programmable ROM (EEPROM), or flash memory. Volatile memory 920 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 912 also includes removable/non-removable, volatile/non-volatile computer storage media. FIG. 8 illustrates, for example a disk storage 924. Disk storage 924 includes, but is not limited to, devices like a magnetic disk drive, floppy disk drive, tape drive, Jaz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 8 describes software that acts as an intermediary between users and the basic computer resources described in the suitable operating environment 900. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that the claimed subject matter can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940, which require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A method for the creation of HTML backgrounds, comprising:
providing a computer system executing instructions for transforming background images;
providing a background image;
separating the background image into nine sub-images defined as four corner images, two horizontal connector images, two vertical connector images, and one center image; and
transforming the corner images into non-tiling corner images, the two horizontal connector images into horizontal tiling images, the two vertical connector images into vertical connector tiling images, and the center image into a vertical and horizontal tiling image,
wherein the background image becomes scalable vertically and horizontally without distortion of the corners.

2. The method recited in claim 1, wherein the aspect ratio of the corners is variable.

3. The method recited in claim 1, wherein the aspect ratio of the corner is fixed.

4. The method recited in claim 1, wherein the sub-images are created in accordance with four lines that bisect the background image.

5. The method recited in claim 4, wherein two of the four lines are horizontal relative to the background image.

6. The method recited in claim 4, wherein two of the four lines are vertical relative to the background image.

7. A system for providing background images, comprising:
A computer running software for transforming background images into non-distorting scalable images.
